(19) United States
(12) Patent Application Publication
(10) Pub. No.: US 2018/0132643 A1
(43) Pub. Date: May 17, 2018

(54) An Intelligent Liquid Intake Measurement Device

(71) Applicant: Avishai Shklar, Kfar Vitkin (IL)

(72) Inventor: Avishai Shklar, Kfar Vitkin (IL)

(21) Appl. No.: 15/557,108

(22) PCT Filed: Mar. 9, 2016
(86) PCT No.: PCT/IL2016/050258

§ 371 Date: Sep. 10, 2017

Related U.S. Application Data
(60) Provisional application No. 62/131,462, filed on Mar. 11, 2015.

(30) Foreign Application Priority Data
Jul. 2, 2015 (IL) 239756

(51) Int. Cl. A47G 23/16; A47G 19/22; G01C 9/24; G01F 23/26

(52) U.S. Cl. CPC A47G 23/16; A47G 19/2227; G01C 2009/182; G01F 23/266; G01F 23/268; G01C 9/24

(57) ABSTRACT

The present invention relates to a liquid retaining device for providing the actual amount of liquid intake by a user, comprising: a) a container body having a bottom wall and side walls, wherein the inside surface of the bottom and side walls is a non-conductive layer; b) at least one pair of sensors in form of capacitive strips that are embedded within the side walls in such a way that each strip extends from top to bottom of the side wall, such that the non-conductive layer serves as a dielectric in a capacitor composed of said capacitive strips a conductive liquid within said container body, thereby the readings of said sensors indicates the liquid level inside the container body across the side wall; and c) an electronic module that includes a control logic for handling the readings of said sensors, thereby enabling to convert said readings into the actual amount of liquid intake.

### FIELD OF THE INVENTION

The present invention relates to the field of liquid intake monitoring systems. More particularly, the invention relates to a liquid retaining device that may be used to measure, record, and monitor liquid intake by a user.

### BACKGROUND OF THE INVENTION

At present there is no real time and continuous feedback solution that is able to monitor liquid level consumption in portable liquid retaining devices, such as water containers, bottles and cups.

It is an object of the present invention to provide a liquid retaining device capable of measuring the amount of liquid used or consumed and accordingly generating alerts and notifications upon preconfigured thresholds.

It is another object of the present invention to monitor liquid consumption from several liquid retaining devices associated with a specific user remotely and in a centralized manner.

Other objects and advantages of the invention will become apparent as the description proceeds.

### SUMMARY OF THE INVENTION

The present invention relates to a liquid retaining device for providing the actual amount of liquid intake by a user, comprising:
a) a container body having a bottom wall and side walls, wherein the inside surface of the bottom and side walls is a non-conductive layer;
b) at least one pair of sensors in form of capacitive strips that are embedded within the side walls in such a way that each strip extends from top to bottom of the side wall, such that the non-conductive layer serves as a dielectric in a capacitor composed of said capacitive strips a conductive liquid within said container body, thereby the readings of said sensors indicates the liquid level inside the container body across the side wall; and
c) an electronic module that includes a control logic for handling the readings of said sensors, thereby enabling to convert said readings into the actual amount of liquid intake.

According to an embodiment of the invention, each pair of capacitive strips may provide different level readings when the liquid level inside the container body is not equal across the side walls, thereby enabling to calculate the tilting angle of said device.

According to an embodiment of the invention, the control logic enables to distinguish between drinking action or draining action of the liquid resides in said device, by monitoring the distinctive pace and pattern the liquid is removed from said device.

According to an embodiment of the invention, the electronic module is situated within a sealed compartment located under the bottom wall.

According to an embodiment of the invention, the electronic module includes a transmission module for enabling said device to communicate with a corresponding mobile terminal.

According to an embodiment of the invention, the mobile terminal is configured to communicate with a server that is adapted to maintain liquid container data per each liquid retaining device or group of liquid retaining devices associated with the same user.

In another aspect the invention relates to a liquid metering system for measuring the current liquid level and the actual amount of liquid intake through a liquid retaining device, comprising: a liquid retaining device adapted to measure the liquid level within a container body of said device by processing readings from a set of sensors embedded within said device, while enabling to communicate said readings to a server via a mobile terminal, wherein said server is adapted to maintain liquid container data per each liquid retaining device or group of liquid retaining devices associated with the same user.

According to an embodiment of the invention, the set of sensors are at least one pair of capacitive strips embedded within side walls of the container body in such a way that each strip extends from top to bottom of said side walls.

In another aspect the invention relates to a method of measuring the current liquid level and the actual amount of liquid intake through a liquid retaining device, comprising: measuring the liquid level inside a container body of said device by using a set of sensors embedded, wherein the reading of said set of sensors enables to detect the tilting angle of said device.

According to an embodiment of the invention, the method further comprises enabling to distinguish between drinking action or draining action of the liquid resides in the device, by monitoring the distinctive pace and pattern the liquid is removed from said device using the reading provided by said set of sensors.

In yet another aspect, the present invention relates to an intelligent liquid metering system consisting of a liquid retaining device, a set of sensors adapted to capture the liquid level, a controller, a wireless transmission module, a mobile terminal (e.g., a smartphone) and a server that may reside on the cloud. The system is used for measuring the current liquid level and the actual total amount of liquid intake through the liquid retaining device.

According to an embodiment, the sensors, controller and the wireless transmission module are arranged on the body of the liquid retaining device. The controller is electrically connected with the measuring sensors and the wireless transmission module. The wireless transmission module is wirelessly communicating with the mobile terminal. The sensors readings may represent the liquid level or the draining rate depending on the usage mode of liquid retaining device. The readings are acquired by the controller that processes the signals of the readings and accordingly provides data messages that indicate the actual liquid intake.

According to an embodiment of the invention, the data messages can be transmitted to the mobile terminal via the wireless transmission module (e.g., using Bluetooth, Wi-Fi, or other suitable data communication protocol or method).

According to an embodiment of the invention, a dedicated application in the mobile terminal is adapted to perform data synchronization with the server via a network, such as the internet.

In another aspect, the present invention relates to an add-on device for an existing liquid retaining device for providing the actual amount of liquid intake by a user through said liquid retaining device, comprising: a) cup attachment means having a top coupling member and bottom coupling member adapted to fit the top and bottom of the existing liquid retaining device, respectively; b) at least one pair of sensors in form of capacitive strips that extends from the top coupling member to the bottom coupling member, wherein said sensor adapted to provide readings of the liquid level within the liquid retaining device; and c) an electronic module electrically connected with said sensors through said cup attachment means, for handling the readings of said sensors.

Via the dedicated application a user can be prompted for the liquid level in the liquid retaining device and additional preconfigured system status and alerts parameters, such as the amount of liquid passed through the liquid retaining device.

### BRIEF DESCRIPTION OF THE DRAWINGS

In the drawings:

FIG. 1 schematically illustrates a liquid retaining device, according to an embodiment of the invention;

FIG. 2 schematically illustrates a block diagram of a liquid level monitoring system, according to one embodiment of the present invention;

FIG. 3 schematically illustrates a liquid retaining device provided with two pairs of capacitive strips, according to an embodiment of the invention;

FIG. 4 schematically illustrates in a block diagram form of an electronic module for enabling the operation of the liquid retaining device as an intelligent liquid intake measurement device, according to an embodiment of the invention; and

FIG. 5 schematically illustrates an add-on device for converting an existing liquid retaining device into an intelligent liquid intake measurement device, according to an embodiment of the invention.

### DETAILED DESCRIPTION OF THE INVENTION

Throughout this description the term “liquid retaining device” or “liquid intake measurement device” are used interchangeably to indicate an essentially vertical container adapted to hold liquid material, such as water or beverage. This term does not imply any particular shape, construction material or geometry, and invention is applicable to all suitable liquid holding containers.

The present invention provides a liquid intake measurement device that may be used to provide information regarding the volume, time, and rate, of a liquid that is consumed from the liquid intake measurement device for a particular drinking episode, along with associated events such as location based information, weather, temperature, fitness records, etc.

Data collected from the liquid intake measurement device can be wirelessly transmitted to a remote location for processing or can be processed by a processing module embedded within the liquid intake measurement device itself. An algorithm harnesses the collected data to provide users of this device with relevant information about liquid intake. Users of the device can access the information through software applications (e.g., mobile apps) or other dedicated software programs developed for this purpose for use on a mobile device such as a smartphone or as an interface for personal computers, remote monitoring systems, and other electronic systems that exchange information. The app may suggest the user on the daily recommended water intake amount given the personal details, location based information, weather, temperature and fitness records Feedback loops may also be incorporated into the algorithm such that the user of the device will receive auditory and visual prompts for drinking. According to some embodiments of the invention, sensors reside in the mobile device can be used to update preconfigured parameters and thresholds as received from other apps such as weather apps, fitness apps, etc.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

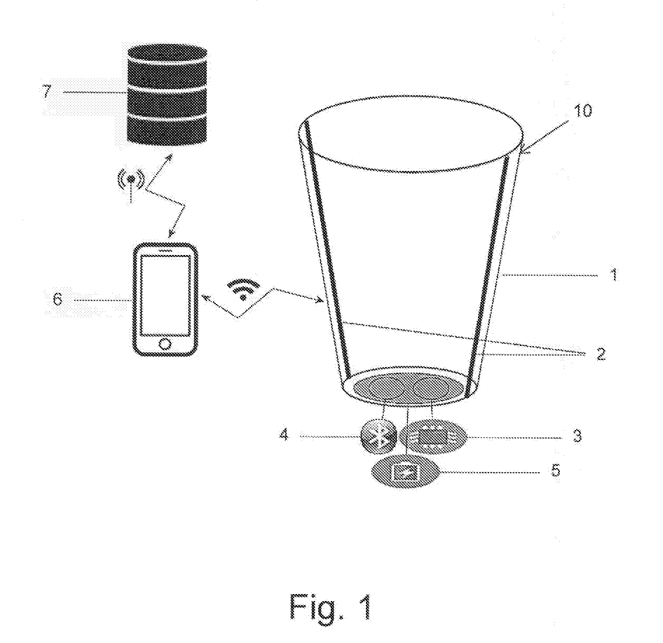

FIG. 1 schematically illustrates a liquid retaining device 10, according to an embodiment of the invention. Device 10 includes a container body 1 (e.g., in form of a cup), a liquid level sensor 2, a controller 3, a wireless transmission module 4, and a power source module 5 that may include a battery and a power supply circuit. In some embodiments, the power source module may consist of a battery and an inductive coil to enable wireless charging.

The wireless transmission module 4 enables to communicate with a corresponding mobile terminal 6 and thereby with a server 7. The transmission module can be using Bluetooth, ZigBee, Wi-Fi, or any other suitable data communication arrangement. In some embodiments, in addition to the wireless transmission module 4, an I/O port (not shown) such as a Universal Serial Bus (USB) can be used as an offline communication channel between device 10 and an external computer system (e.g., a Personal Computer) or an external USB memory medium. The mobile terminal 6 can be a smartphone, a tablet or any other computing device that allows access to the data collected by device 10 through software applications such as mobile apps.

Another object of the present invention is to provide a networked system that provides the functions of monitoring, alarming, and controlling the liquid retaining device 10 via the mobile terminal or the Internet.

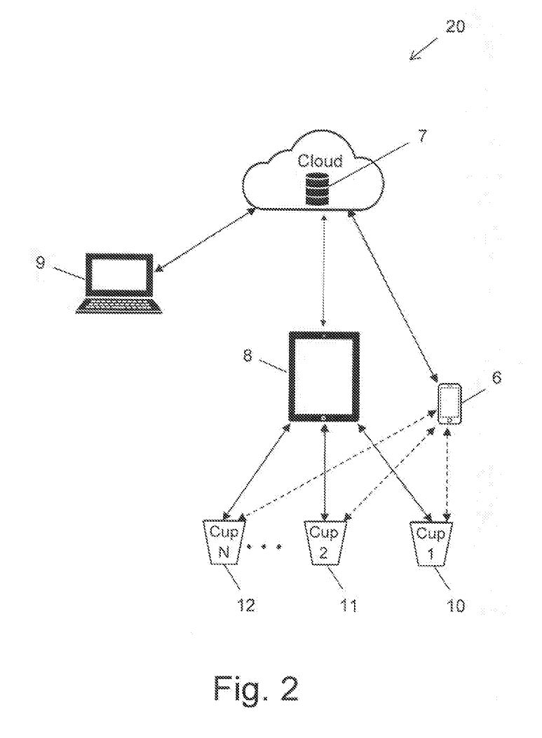

The objective of server 7 is to maintain liquid container data per each liquid retaining device, group of liquid retaining devices associated with the same user, managing registered users data, in order to maintain all received information and configuration. FIG. 2 schematically illustrates a block diagram of a liquid level monitoring system 20, according to one embodiment of the present invention. In this embodiment, system 20 maintains plurality of liquid retaining devices 10, 11 and 12, each associated with the same user (although in other embodiments each device can be associated with a different user). In this embodiment, the user may use more than one terminal device (e.g., a smartphone 6 and tablet 8), e.g., to view data related to the daily liquid consumption or to interact with server 7 (e.g., add new liquid retaining device). Each liquid retaining device has a unique identification code that may also reflect the devices parameters, such as container volume or maximum liquid capacity. Optionally, a “power user” can observe the actual liquid consumption of multiple users that are defined as “sub users” under such “power user” as indicated by numeral 9 in FIG. 2.

The invention utilizes capacitance as the mode of sensing the level/volume of liquid in device 10. According to an embodiment of the invention the liquid level sensors 2 are one or more pairs of capacitive strips adapted to develop the capacitance. The capacitive strips are adapted to be extended from top of container body 1 to the bottom of container body 1. In some embodiments, the capacitive strips are embedded within the wall of the container body 1. In cases where using only limited number of pairs of sensors, the liquid level measurement may not be taken while the cup is being tilted or shaken.

In other embodiments, the capacitive strips (i.e., sensor 2) together with the electrical components (i.e., the controller 3, the transmission module 4, and the power source module 5) can be provided as an add-on device adapted to be coupled to existing cups (i.e., simple/regular existing liquid retaining device), thereby enabling to convert any existing cup to an intelligent liquid intake measurement device.

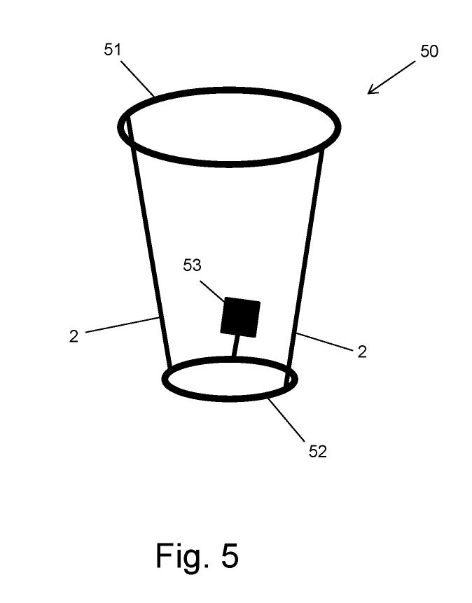

FIG. 5 shows a device that can be used in conjunction with the invention. The device illustrated in this figure is particularly convenient because it can be applied as an ad-on device to existing liquid retaining device (e.g., cups, vessels, containers, bottles, and the like) without the need to carry out any alterations in the structure of such existing liquid retaining devices. The device generally indicated by numeral 50 in the figure comprises at least one pair of capacitive strips (i.e., sensor 2), cup attachment means 51, 52 adapted to fit the top and bottom of a cup or other existing liquid retaining device and a casing 53 for covering the electrical components such as the controller, the transmission module, and the power source module). For example, the cup attachment means can be two flexible rings as indicated by numeral 51 and 52 that are connected via the sensor 2 that extends from the top ring 51 to the bottom ring 52. The casing 53 can be attached to one of the rings, while the electrical components are electrically connected with sensors 2 through wiring embedded within at least one of the rings. Of course, the shape of the cup attachment means can be varied according to the forms of the liquid retaining device (e.g., the cup attachment means may have an oval shape, rectangular shape, etc.).

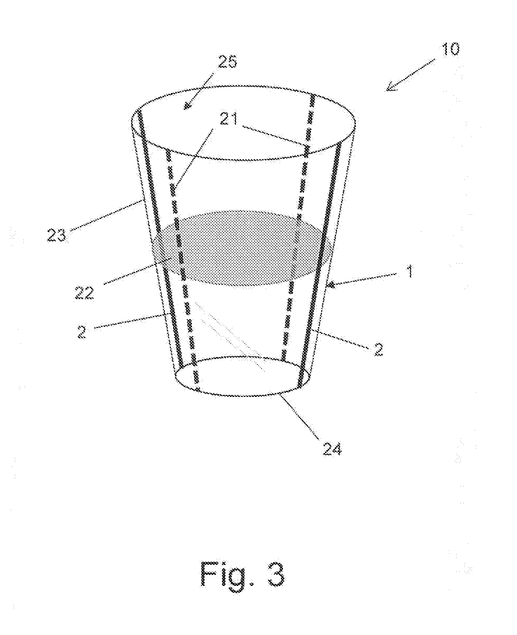

According to some embodiments of the invention, the container body 1 of device 10 may include plurality of pairs of capacitive strips. For example, FIG. 3 shows the body 1 of device 10 provided with two pairs of capacitive strips as indicated by numerals 2 and 21. In order to easily distinguish in this figure between the two pairs, the capacitive strips 21 are illustrated in dotted lines. In some usages episodes of device 10, different level readings from each pair of sensors can be used to calculate the current angle of the liquid with respect to the walls of device 10 (i.e., due to the tilt position of device 10), as one pair may read a lower level while at the same time the other pair may read a higher level. Such differences in the readings can be used to calculate the current angle of the liquid. The more pair of sensors are used the more accurate tilt information can be obtained. Such readings can be processed in order to determine whether a user consumes the liquid or just emptying device 10, in addition different information can be further obtained such as the rate of consumption, consumption patterns, etc.

The above-discussed capability is achievable in the illustrative embodiments of the present invention shown in FIG. 3. The container body 1 in which is disposed a conductive liquid (the level of the conductive liquid is indicated by numeral 22). The container body 1 includes side walls 23, and a bottom wall 24. The capacitive strips 2 and 21 are extend from top to bottom of the side wall 23 (as best shown in FIGS. 1 and 3), and can be made of conductive material such as aluminum, or might include metal-coated plastic strips, and the like. The electrical components such as the controller 3, the wireless transmission module 4 and the power source module 5 can be situated in a sealed compartment located under the bottom wall 24 (as shown in FIG. 1), between double walls or on the side wall. According to some embodiments, the capacitive strips 2 and 21 are embedded within the side walls 23.

On the inside of the container body 1, disposed against the inside surface of the walls, is a non-conductive layer 25 or covered by such a non-conductive layer. Layer 25 is disposed over the entire inside surface of body 1 and is made, for example, of non-conductive polymers such as polyethylene, polyamide, polyester, and the like.

The power source module supplies a charge to the capacitive strips 2 and 21. The non-conductive layer 25 serves as a dielectric in a capacitor composed of the conductive capacitive strips and the conductive liquid. Since capacitance depends upon the area of the capacitive strips, the capacitance produced in the container body 1 will depend upon the level or volume of the conductive liquid in device 10. That is, the greater the volume of the liquid in the container body 1 of device 10, the greater will be the charge which the container body 1 can hold, and vice versa. Thus, the amount of charge being held by device 10 provides an indication of the volume of liquid in the container body 1.

The amount of this charge or the capacitance is calculated by the controller 3. The measure of the capacitance thus provides a measure of the volume of liquid in device 10.

Such configuration enables the capacitance readings to be proportional to the volume of liquid in device 10. This provides for a simple and lightweight approach to measuring the volume of conductive liquid contained in device 10.

According to some embodiments of the present invention, the liquid level sensors 2 may use the capacitive sensing technology described hereinabove in a specific method for enabling an algorithm to distinguish between regular liquid usage (i.e., drinking episode, e.g., water consumption) and container draining (i.e., non-drinking episode). For example, the regular liquid usage can be defined according to specific drinking patterns based on an expected or patterns that define normal/regular user water consumption rate and/or tilting angle of device 10 that define drinking episodes, while the container draining can be defined according to draining patterns that are based on specific tilt angle and/or patterns that may define emptying action.

An application on the mobile terminal 6 receives the data and display the container liquid level status to the user. In addition the application can prompt the user on several preconfigured conditions and thresholds i.e., liquid fill or empty rate, reached to max liquid intake threshold per period of time.

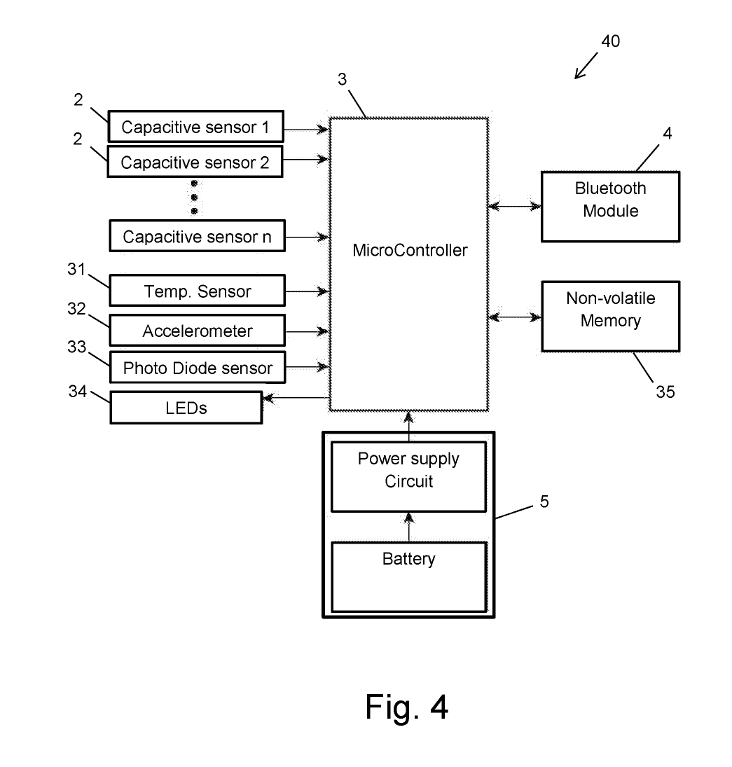

Referring now to FIG. 4, an electronic module 40 for enabling the operation of the liquid retaining device_as_an intelligent liquid intake measurement device, is shown in a block diagram form in accordance with an embodiment of the invention. In this embodiment, device 10 may include at least some of the following configurations:
1. Controller 3 is connected to a non-volatile memory 35 for liquid parameters storage such as liquid level readings together with timestamp;
2. An optional display screen (not shown) may reside on the side walls of device 10 itself or be connected in a wire or wireless manner to the controller 3;
3. The logic that calculates the liquid parameters, can be processed by controller 3 or by the application software on the mobile terminal 6;
4. A detector 33 (e.g., a photodiode) that monitors liquid transparency is assembled in device 10. For example, photodiode information can be processed by the controller 3 and indicate the liquid type (i.e., may act as a type of a spectrophotometer detector). An optional temperature sensor 31 can be used to detect the temperature of the liquid within device 10 (e.g., to distinguish between a hot or cold type of beverage).
5. The logic can distinguish between drinking or draining actions of the liquid in the container, by monitoring the distinctive pace and pattern the liquid is removed from the container and/or by detecting a certain tilting angle of the liquid within the container (e.g., using the liquid level sensors 2) or of the container itself (e.g., using tilt sensors such as an accelerometer 32) which is different than a preconfigured “normal drinking” angle with respect to a reference plane (e.g., comparing to the horizon);
6. A LED 34 or other indicator (visual, audible or both) can be used to indicate when liquid is added to the container, on battery level status, when maximum threshold is crossed or other alarms and indications that can be preset by the user, e.g., for reminding the user to consume water;
7. More than one liquid retaining device can be connected to the mobile terminal 6 simultaneously, i.e., the application software may handle plurality of different liquid retaining devices as described hereinabove with respect to FIG. 2;
8. More than a single liquid retaining device can be assigned to a user in the server 7;
9. A “power user” that can observe the actual liquid consumption of multiple users that are defined as “sub users” under such “power user”.
10. Plurality of pairs of capacitive strips (i.e., sensors 2).

Due to its novel structure as described hereinabove, the inventive liquid retaining device of the present invention is able to measure the rate and quantity of liquids consumed from the container body.

In the exemplary FIG. 1, the container body 1 of device 10 is in the form of a cup, which can be disposable or reusable. In an exemplary embodiment, container body 1 is constructed from a transparent or a translucent material such that light is able to pass through the walls of the body. Container body 1 can hold hot liquids as well as cold liquids.

Additionally, container body 1 can be graduated so that a volume of liquid within container body 1 can be visually determined. Optionally, container body 1 can be fitted with a removable lid (not shown) to prevent spillage. Device 10 can be provided in variety of sizes and liquid capacities as required by different users and that might suite different uses. For example, container body 1 may be a 250 ml cup that is about 10 cm high and about 7 cm in diameter.

FIG. 2 and the following discussion are intended to provide a brief, general description of a suitable computing environment in which the invention may be implemented. While the invention described hereinabove in the general context of program modules that execute in conjunction with an application program that runs on the liquid retaining device and/or on an operating system of a mobile device, those skilled in the art will recognize that the invention may also be implemented in combination with other program modules and devices.

Moreover, those skilled in the art will appreciate that the invention may be practiced with other computer system configurations, including hand-held devices, multiprocessor systems, microprocessor-based or programmable consumer electronics, minicomputers, mainframe computers, and the like. As shown in FIG. 2, the invention can be practiced in distributed computing environments where tasks are performed by remote processing devices that are linked through a communications network. In a distributed computing environment, program modules may be located in both local and remote memory storage devices.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

As will be appreciated by the skilled person the arrangement described in the figures results in a liquid retaining device capable of measuring the amount of liquid used or consumed and accordingly generating alerts and notifications upon preconfigured thresholds

All the above description and examples have been given for the purpose of illustration and are not intended to limit the invention in any way. Many different capacitive mechanisms, methods of analysis the liquid consumption, electronic and logical elements can be employed, all without exceeding the scope of the invention.

1. A liquid retaining device for providing the actual amount of liquid intake by a user, comprising:
a) a container body having a bottom wall and side walls, wherein the inside surface of the bottom and side walls is a non-conductive layer;
b) at least one pair of sensors in form of capacitive strips that are embedded within the side walls in such a way that each strip extends from top to bottom of the side wall, such that the non-conductive layer serves as a dielectric in a capacitor composed of said capacitive strips and a conductive liquid within said container body, thereby the readings of said sensors indicates the liquid level inside the container body across the side wall as each sensor may provide different level of readings when the liquid level inside the container body is not equal across the side wall, thereby enabling to calculate the tilting angle of said device; and
c) an electronic module that includes a control logic for handling the readings of said sensors, thereby enabling to convert said readings into the actual amount of liquid intake.

2. A device according to claim 1, in which the differences in the readings is used to calculate the current angle of the liquid, so that as more pairs of sensors are used the more accurate tilt information is obtained.

3. A device according to claim 1, further comprising an accelerometer for enabling calculation of the tilting angle of said device.

4. A device according to claim 1, in which the control logic enables to distinguish between drinking action or draining action of the liquid resides in said device, by monitoring the distinctive pace and pattern the liquid is removed from said device.

5. A device according to claim 1, in which the electronic module are situated within a compartment located anywhere on said device, including under the bottom wall, between double walls or on the side wall.

6. A device according to claim 1, in which the electronic module includes a transmission module for enabling said device to communicate with a corresponding mobile terminal.

7. A device according to claim 1, in which the mobile terminal is configured to communicate with a server that is adapted to maintain liquid container data per each liquid retaining device or group of liquid retaining devices associated with the same user.

8. A device according to claim 1, in which the electronic module further comprises a detector adapted to monitor the transparency of the liquid within said device, thereby enabling the controller to indicate the type of liquid.

9. A liquid metering system for measuring the current liquid level and the actual amount of liquid intake through a liquid retaining device, comprising: a liquid retaining device adapted to measure the liquid level within a container body of said device by processing readings from a set of sensors in form of capacitive strips embedded within said device wherein one sensor may read a lower level while at the same time another sensor may read a higher level and the differences in the readings is used to calculate the current angle of the liquid, while enabling to communicate said readings to a server via a mobile terminal, wherein said server is adapted to maintain liquid container data per each liquid retaining device or group of liquid retaining devices associated with the same user.

10. A system according to claim 9, in which the capacitive strips are embedded within the side walls of the container body in such a way that each strip extends from top to bottom of said side walls, such that each sensor may provide different levels of readings when the liquid level inside the container body is not equal across the side wall, thereby enabling calculation of the tilting angle of said device.

11. An add-on device for converting an existing container into an intelligent liquid intake measurement device, comprising:
a) cup attachment means adapted to be coupled to said existing container;
b) at least one pair of sensors in form of capacitive strips that extends from the top to the bottom of said container, wherein said at least one pair of sensors is adapted for providing readings of the liquid level within said container; and
c) an electronic module electrically connected with said sensors through said cup attachment means, for handling the readings of said sensors.

12-13. (canceled)

14. An add-on device according to claim 11, in which the cup attachment means comprise a top coupling member and a bottom coupling member adapted to fit the top and bottom of the container, respectively.

15. An add-on device according to claim 11, in which the cup attachment means are two flexible rings, a top ring and a bottom ring, that are connected via the at least one pair of sensors that extends from said top ring to said bottom ring.

16. An add-on device according to claim 13, in which the electronic module is covered by a casing that is attached to one of the rings, while the electrical components are electrically connected with the sensors through wiring embedded within at least one of the rings.

17. A method of measuring the current liquid level and the actual amount of liquid intake through a liquid retaining device, comprising:
a) measuring the liquid level inside a container body of said device by using a set of sensors in form of capacitive strips that extends from the top to the bottom of said container;
b) providing readings of the liquid level within the liquid retaining device from each sensor, such that different levels of readings from each capacitive strip are used to calculate the current angle of the liquid with respect to the walls of said device, as one sensor may read a lower level while at the same time another sensor may read a higher level; and
c) calculating the tilting angle of said device from said different levels of readings.

18. A method according to claim 17, further comprising processing said readings and thereby enabling to distinguish between drinking or draining actions of the liquid resides in the device, by monitoring the distinctive pace and pattern the liquid is removed from said device using the reading provided by said set of sensors.
